(19) United States
(12) Patent Application Publication
(10) Pub. No.: US 2026/0154682 A1
(43) Pub. Date: Jun. 4, 2026

(54) SYSTEM AND METHODS FOR REAL-TIME PROCESSING OF CARD-BASED RESOURCE TRANSFERS

(71) Applicant: The Toronto-Dominion Bank, Toronto (CA)

(72) Inventors: Francis James Alexander GUTTRIDGE, Toronto (CA); Michael Gregory McCANN, Mississauga (CA); Kishore Chandradev Reddy PALLE, Cherry Hill, NJ (US); Dino Paul D'AGOSTINO, Richmond Hill (CA); Jonathan Richard Channing RICHARDS, Toronto (CA); Lakshmipriya PALLE, Cherry Hill, NJ (US); Edward William RATCLIFFE, Toronto (CA); Parixit D. GANDHI, Brampton (CA)

(73) Assignee: The Toronto-Dominion Bank, Toronto, ON (CA)

(21) Appl. No.: 18/964,771

(22) Filed: Dec. 2, 2024

(51) Int. Cl. G06Q 20/40; G06Q 20/10; G06Q 30/0226

(52) U.S. Cl. CPC G06Q 20/401; G06Q 20/10; G06Q 30/0226

(57) ABSTRACT

A processor-implemented method is disclosed. The method includes: detecting a first resource transfer initiated using a first value transfer card; identifying an alternative value transfer card for processing the first resource transfer based on transfer data of the first resource transfer and card data of the first and alternative value transfer cards; presenting, via a computing device, a prompt for receiving input of a selection of one of the first and alternative value transfer cards; in response to determining that the selection is the first value transfer card, processing the first resource transfer using the first value transfer card; and in response to determining that the selection is the alternative value transfer card, declining the first resource transfer.

### TECHNICAL FIELD

The present application relates to value transfer cards and, more particularly, to a system and methods for real-time processing of resource transfers initiated using value transfer cards.

### BACKGROUND

Value transfer cards, such as debit and credit cards, may be used by customers for various types of resource transfers. For example, a value transfer card may enable a cardholder to make purchases at a point-of-sale (e.g. a merchant terminal) or access an automatic teller machine (ATM) for account-related operations (e.g. deposits, money transfers, cash withdrawals, etc.). Resource transfers initiated using value transfer cards are typically processed by computing systems that perform backend services relating to authorization, identity verification, and clearing and settlement.

### BRIEF DESCRIPTION OF THE DRAWINGS

Embodiments are described in detail below, with reference to the following drawings:

FIG. 1 is a schematic diagram illustrating an exemplary computing environment in which embodiments of the present disclosure may be implemented;

FIG. 2A is high-level schematic diagram of an example computing device;

FIG. 2B shows a simplified organization of software components stored in a memory of the example computing device of FIG. 2A;

FIG. 3 shows, in flowchart form, an example method for real-time processing of resource transfers initiated using a value transfer card;

FIG. 4 shows, in flowchart form, an example method for real-time processing of a resource transfer initiated using a value transfer card, with variable resource transfer hold periods; and

FIG. 5 shows, in flowchart form, another example method for real-time processing of resource transfers initiated using a value transfer card.

Like reference numerals are used in the drawings to denote like elements and features.

### DETAILED DESCRIPTION OF VARIOUS EMBODIMENTS

In an aspect, a computing system is disclosed. The computing system includes a processor and a memory coupled to the processor. The memory stores computer-executable instructions that, when executed by the processor, configure the processor to: detect a first resource transfer initiated using a first value transfer card; identify an alternative value transfer card for processing the first resource transfer based on transfer data of the first resource transfer and card data of the first and alternative value transfer cards; present, via a computing device, a prompt for receiving input of a selection of one of the first and alternative value transfer cards; in response to determining that the selection is the first value transfer card, process the first resource transfer using the first value transfer card; and in response to determining that the selection is the alternative value transfer card, decline the first resource transfer.

In some implementations, identifying the alternative value transfer card may include: obtaining a first rewards profile associated with the first value transfer card and a second rewards profile associated with the alternative value transfer card, the rewards profiles indicating quantities of rewards that accrue from processing resource transfers using the respective cards; determining a first rewards quantity associated with the first value transfer card and a second rewards quantity associated with the second value transfer card based on the first and second rewards profiles, respectively; and comparing the first and second rewards quantities.

In some implementations, identifying the alternative value transfer card may include: determining a first currency associated with the first resource transfer; and determining that the alternative value transfer card is preferred over the first value transfer card for resource transfers in the first currency.

In some implementations, presenting the prompt may include sending, to the computing device, a notification indicating a proposed change to the first resource transfer, the notification identifying the alternative value transfer card.

In some implementations, the notification may be presented via the computing device for a defined period of time that begins when the first resource transfer is detected.

In some implementations, the instructions, when executed, may further configure the processor to: in response to determining that a selection is not inputted within the defined period of time, cease presenting the prompt via the computing device and process the first resource transfer using the first value transfer card.

In some implementations, the instructions, when executed, may further configure the processor to: in response to determining that the selection is the alternative value transfer card, cause a second resource transfer to be initiated using the alternative value card transfer by configuring the second resource transfer using transfer data of the first resource transfer.

In some implementations, the computing device may comprise a point-of-sale terminal at which the first resource transfer is detected.

In some implementations, a length of the defined period of time may depend on a resource transfer value of the first resource transfer.

In some implementations, the instructions, when executed, further configure the processor to: determine a first value of rewards associated with use of the first value transfer card for the first resource transfer and a second value of rewards associated with use of the alternative value transfer card; compute a difference between the first value and the second value; and in response to determining that the computed difference does not exceed a defined threshold, process the first resource transfer using the first value transfer card.

In another aspect, a computer-implemented method is disclosed. The method includes: detecting a first resource transfer initiated using a first value transfer card; identifying an alternative value transfer card for processing the first resource transfer based on transfer data of the first resource transfer and card data of the first and alternative value transfer cards; presenting, via a computing device, a prompt for receiving input of a selection of one of the first and alternative value transfer cards; in response to determining that the selection is the first value transfer card, processing the first resource transfer using the first value transfer card; and in response to determining that the selection is the alternative value transfer card, declining the first resource transfer.

In another aspect, a non-transitory computer readable storage medium is disclosed. The computer readable storage medium contains instructions thereon which, when executed by a processor, configure the processor to: detect a first resource transfer initiated using a first value transfer card; identify an alternative value transfer card for processing the first resource transfer based on transfer data of the first resource transfer and card data of the first and alternative value transfer cards; present, via a computing device, a prompt for receiving input of a selection of one of the first and alternative value transfer cards; in response to determining that the selection is the first value transfer card, process the first resource transfer using the first value transfer card; and in response to determining that the selection is the alternative value transfer card, decline the first resource transfer.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

Value transfer cards, such as debit or credit cards, can be used to initiate transfers of resources and/or value. A cardholder may use a value transfer card to, for example, make purchases at a point-of-sale or access an ATM for account-related operations. A value transfer card is typically connected to one or more accounts (e.g., a cardholder account, etc.) storing data and/or resources that are accessible to the cardholder. For example, a value transfer card may be linked to a loyalty points account. Loyalty points are a digital representation of customer engagement rewards within a loyalty management system. Each loyalty point is a discrete unit of value that is used to incentivize repeat resource transfers or customer interactions. Eligible transfers from a cardholder account for a value transfer card are captured, and loyalty points corresponding to the transfers are calculated based on predefined rules. The calculated points can be added to a points balance of the loyalty points account that is linked to the value transfer card.

For cardholders having multiple value transfer cards, the selection of a particular card to use for a resource transfer may depend on several factors. As different cards may be associated with different card features and/or rewards (e.g., loyalty points), the cardholder is presented with the challenge of maximizing the rewards or other benefits accruing from resource transfers that are conducted using the value transfer cards. In particular, each intended resource transfer may present a different optimization problem that is contingent on the transfer details.

When a value transfer card is used by a cardholder to initiate a resource transfer (e.g., a card transaction), an issuing bank associated with the card either approves or declines the resource transfer. The issuer computing system (e.g., issuing bank server) is configured to process the transfer data to perform operations relating to authorization of a requested resource transfer. More particularly, the issuer computing system validates the cardholder's account by checking for sufficient resources, verifying account status (e.g., active or blocked), and analyzing the resource transfer in real-time using fraud detection algorithms. The issuer computing system can control the flow of resource transfer processing by implementing authorization steps that are interposed between the initial resource transfer request and card clearing and settlement. By way of example, the issuer computing system may be adapted to obtain account data of one or more accounts associated with the cardholder and use the account data and transfer data of a requested resource transfer in controlling a resource transfer processing flow.

The present application discloses a system and methods for real-time processing of resource transfers initiated using value transfer cards. A resource transfer processing system, which may comprise an issuer server for value transfer cards, is configured to access card features information and benefits profiles of a plurality of value transfer cards. When a resource transfer is initiated using a value transfer card, the proposed system may interrupt the resource transfer, for example, by causing the resource transfer to be placed on hold. The system determines whether a more optimal card for the resource transfer is available to the cardholder. A more optimal card may, for example, be a card that results in accrual of a greater quantity of rewards, such as loyalty points, from using the card to process the resource transfer. If an “optimal” card is available to the cardholder, the system may cause the resource transfer to be held and notify the cardholder that a different card should be used for the resource transfer.

In some implementations, the proposed system may be adapted to configure an alternative resource transfer that uses the “optimal” card. That is, the system may cause a second resource transfer that is different from the original requested resource transfer to be set up, such that the optimal card may be used to complete the second resource transfer. For example, a requested resource transfer using a value transfer card may effectively be declined and replaced with an alternative resource transfer that is configured for the relevant point of resource transfer (e.g., a POS, online payment interface, etc.). In particular, the system may cooperate with the resource transfer interface to configure the alternative resource transfer for automatic processing or for presenting, to the cardholder, as a selectable option that is different from the requested resource transfer.

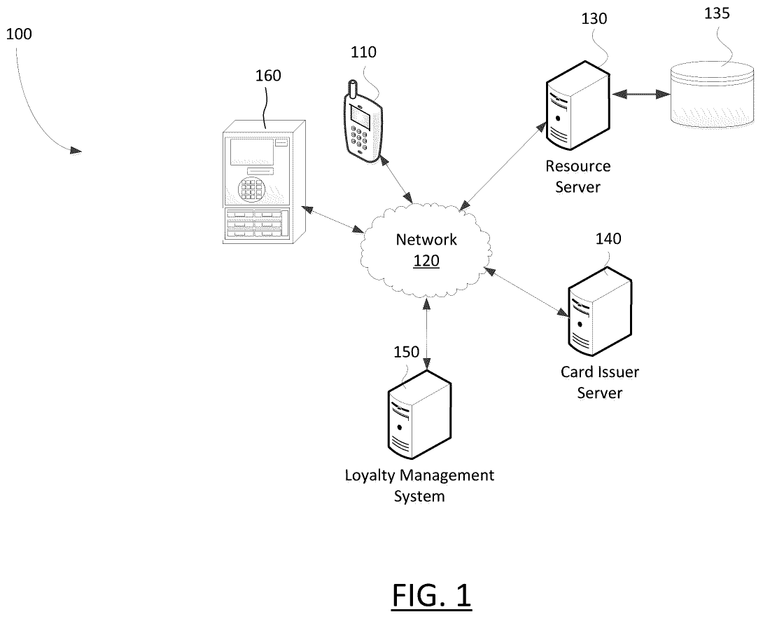

Reference is first made to FIG. 1, which is a schematic diagram illustrating an exemplary computing environment 100 consistent with various embodiments of the present disclosure. As shown in FIG. 1, the computing environment 100 may include one or more client devices 110, a resource server 130, a database 135 associated with the resource server 130, a card issuer server 140, a loyalty management system 150, and a communications network 120 connecting one or more of the components of computing environment 100.

The resource server 130 is a server computer system. The resource server 130 and the client devices 110 communicate via the network 120. In at least some embodiments, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 may be associated with a client entity (e.g., an individual, an organization, etc.) having resources that are managed by or via the resource server 130. For example, the resource server 130 may be a financial institution server and the client entity may be a customer of a financial institution operating the resource server 130. The client device 110 may store software instructions that cause the client device to establish communications with the resource server 130 and, in at least some embodiments, the loyalty management system 150.

The resource server 130 may track, manage, and maintain resources, make lending decisions, and/or lend resources to a client entity associated with the client device 110. The resources may, for example, comprise computing resources (e.g., processor cycles, memory, etc.), digital resources, stored value (e.g., fiat currency), and the like. In at least some implementations, the resources may be represented in a database. For example, the resource server 130 may be coupled to a database 135, which may be provided in secure storage. The secure storage may be provided internally within the resource server 130 or alternatively, it may be provided remotely from the resource server 130. For example, the secure storage may include one or more data centers that store data with bank-grade security.

The database 135 may include data records for a plurality of accounts and at least some of the data records may define a quantity of resources associated with the client entity. For example, the client entity may be associated with an account having one or more data records in the database 135. The data records may reflect a quantity of stored resources that are associated with the client entity. Such resources may include owned resources and, in at least some embodiments, borrowed resources (e.g., resources available on credit). The quantity of resources that are available to or associated with the client entity may be reflected by a balance defined in an associated data record such as, for example, a bank balance.

In at least some embodiments, the database 135 may store various types of information in connection with customers of a business entity that administers the resource server 130. For example, the database 135 may store customer profile data and financial account data associated with customers. The customer profile data may include, without limitation, personal information of registered customers, authentication credentials of the customers, account identifying information (e.g., checking account, savings account, revolving credit line, etc.), and information identifying services (e.g., banking services, investment management services, etc.) and/or programs (e.g., loyalty programs) that are offered to the customers by the business entity. The financial account data may include account balances, historical transfer data, credit score(s), mortgage balances, investment account balances, and portfolio data relating to portfolios of investments that are held by customers, among others.

The business entity associated with the resource server 130 may provide services that are accessible to the client entity. For example, the business entity may provide account management services, financial resource transfer services, investment management services, etc. for the client entity. In at least some embodiments, the business entity may issue value transfer cards (e.g., credit, charge or debit cards) to its customers, including the client entity. In particular, the resource server 130 may be associated with a value transfer card issuer. The value transfer cards issued by the business entity may be associated with resource accounts (of the customers) at the resource server 130. For example, the value transfer cards may be used by customers to access resources of their accounts.

While the card issuer server 140 is illustrated as a standalone computing system in FIG. 1, it will be understood that the card issuer server 140 may be integrated with or implemented as part of other systems. By way of example, the resource server 130 may be associated with a financial institution that is also the issuer entity for a value transfer card. The resource server 130 may implement various functions of the card issuer server 140 in connection with value transfer cards for which it is the issuer entity, i.e., issuing bank.

The computing environment 100 also includes a loyalty management system 150. The loyalty management system 150 is a computing system associated with a loyalty program. In some embodiments, the loyalty management system 150 may be administered by a business entity that is associated with the resource server 130 (e.g., a financial institution). For example, the business entity may offer various loyalty programs to its customers, and the loyalty management system 150 may be associated with one of the loyalty programs. In particular, the loyalty management system 150 may be implemented by or as part of the resource server 130.

The loyalty programs may, for example, be linked to value transfer cards that are offered to customers of the business entity. A customer may register or sign up for a value transfer card that is offered by the business entity, and the value transfer card can be connected to a loyalty program. When the customer uses the value transfer card to complete a resource transfer (e.g., purchases, bill payments, etc.), the loyalty management system 150 validates the resource transfer against loyalty rules, calculates loyalty points based on the resource transfer value and rule parameters, and credits a loyalty program account associated with the customer by adding the calculated points to the customer's loyalty balance.

The loyalty management system 150 implements various functions relating to a loyalty program. In particular, the loyalty management system 150 may track, manage, and maintain loyalty points information for a plurality of accounts associated with the loyalty program.

The computing environment 100 may integrate a transfer rail server (not shown). The transfer rail server communicates with remote computing devices via the network 120. The remote computing devices may take a variety of forms. For example, as illustrated, the transfer rail server may communicate with point-of-sale (POS) terminals, automated teller machines (ATMs) 160, and/or one or more other computing devices such as, for example, one or more transfer initiation systems (e.g., transferee/payee entities). The transfer rail server is a back-end system that facilitates electronic funds transfer and may, in at least some embodiments, be referred to as payment rails. By way of example, the transfer rail server may be a Visa™, Mastercard™, or American Express™ server. The transfer rail server may be associated with a particular brand of value transfer cards. More particularly, the transfer rail server may facilitate payment processing for a particular brand of value transfer cards, such as a brand of credit and/or charge card. The transfer rail server may also, in some embodiments, be referred to as a credit card network server.

In order to process a transfer of value using the value transfer card, a POS terminal, an ATM, or other transfer initiation system communicates with the transfer rail server. For example, a transfer initiation system may send, to the transfer rail server, a transfer request. The transfer request may specify, for example, an amount of value associated with the request. The transfer request may also include or be associated with one or more credentials associated with a value transfer card. The credentials may include, for example, the PAN, expiry date, and/or verification number for the value transfer card. Other metadata may also be included in the transfer request such as, for example, an entity identifier such as a merchant identifier, location information specifying a location at which the transfer initiation system purports to be located, and/or other information.

The credentials may take other forms. For example, the credentials may include a token. A token may be a non-decryptable piece of data that is used to represent, by reference, value transfer card data. Tokens may be issued by a tokenization service, which may be included in the transfer rail server or may be a separate system. The tokenization service and/or the transfer rail server stores a mapping of a token to associated information such as, for example, value transfer card data. For example, the token may be mapped to one or more of an account number such as a PAN, a date (e.g. expiry date), verification data (e.g. CCV number), and/or a token holder. The token holder may identify an entity that the token was issued to and/or is associated with, such as the transfer rail server. For example, the transfer rail server may permit one or more third party systems to obtain and store a token for a particular value transfer card. The token is a representation of the value transfer card and may be stored by the transfer initiation system for future use in issuing value transfer requests. The token may be unique to the entity to which it is issued. That is, different entities that receive tokens for the same value transfer card may receive different tokens, and the transfer rail server and/or the tokenization service may track which entity received which token so that an entity that issued a value transfer request that includes a token may be identified.

After the transfer rail server receives a value transfer request, it may communicate with an issuer computing system to request approval of the value transfer request. The request for approval may include, for example, information included in or obtained from the value transfer request, such as the amount of the requested transfer. The request for approval may include information determined based on the token. For example, the PAN may be included in the request. The transfer rail server subsequently receives a response to the request for approval (e.g., either an indication of approval or an indication of denial) and sends a corresponding message to the transfer initiation system.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like. Additionally, or alternatively, the network 120 may be or may include one or more payment networks. The network 120 may, in some embodiments, include a plurality of distinct networks. For example, communications between certain of the computer systems may be over a private network whereas communications between other of the computer systems may be over a public network, such as the Internet.

The integrated system architecture that includes the card issuer server 140 and the loyalty management system 150 provides a robust environment for managing customer resource transfers and loyalty points simultaneously. The card issuer server 140 implements an authorization engine that validates requested resource transfers. In particular, resource transfers may be authorized in real-time by verifying cardholder credentials, balance, and/or fraud checks. Customer resource transfers are tracked by the card issuer server 140, and customer accounts are updated in real-time to reflect changes to account balance. The transfer data of resource transfers is provided to the loyalty management system 150 such that loyalty points can be calculated.

The client device 110, the resource server 130, the card issuer server 140, and the loyalty management system 150 may be in geographically disparate locations. Put differently, the client device 110 may be remote from at least one of: the resource server 130, the card issuer server 140, and the loyalty management system 150. As described above, each of the client device 110, the resource server 130, the card issuer server 140, and the loyalty management system 150 may be a computer system.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like. Additionally, or alternatively, the network 120 may be or may include one or more payment networks. The network 120 may, in some embodiments, include a plurality of distinct networks. For example, communications between certain of the computer systems may be over a private network whereas communications between other of the computer systems may be over a public network, such as the Internet.

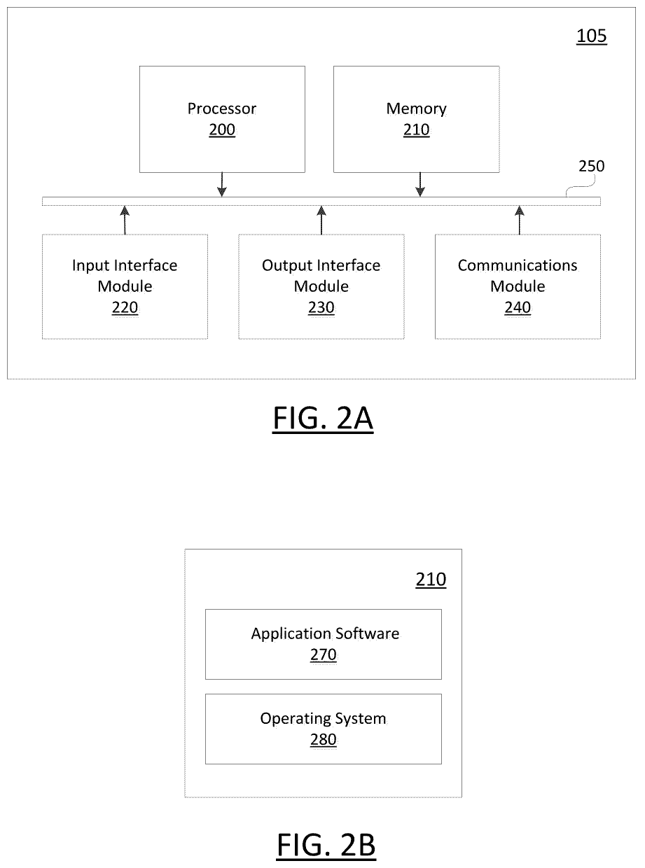

FIG. 2A is a high-level operation diagram of an example computing device 105. In at least some embodiments, the example computing device 105 may be exemplary of one or more of: the client device 110, the resource server 130, the card issuer server 140, and the loyalty management system 150. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor and may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. For example, the application software 270 may cooperate with the operating system 280 to adapt a suitable embodiment of the example computing device 105 to operate as the client device 110, the resource server 130, the card issuer server 140, or the loyalty management system 150. While a single application software 270 is illustrated in FIG. 2B, in operation, the memory 210 may include more than one application software 270 and different application software 270 may perform different operations.

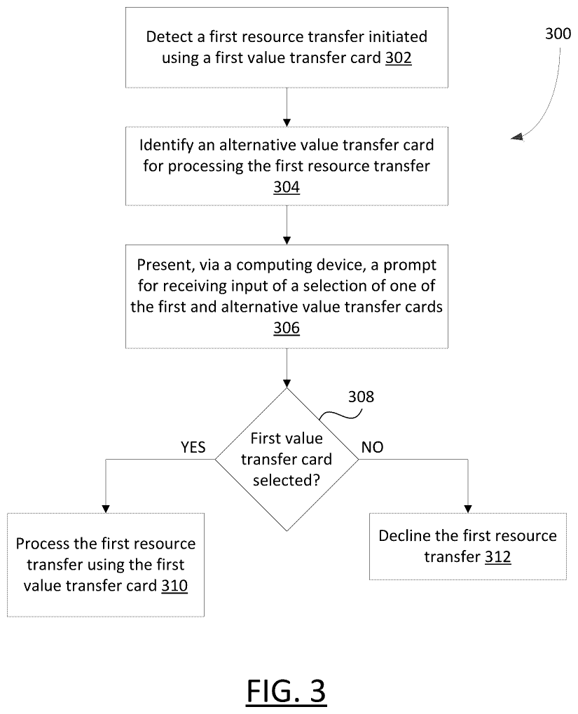

Reference is now made to FIG. 3 which shows, in flowchart form, an example method 300 for real-time processing of resource transfers that are initiated using a value transfer card. The method 300 may be implemented by a computing system associated with an issuer entity for the value transfer card. For example, the method 300 may be executed by a computing system implementing the card issuer server 140 or a resource server 130 that is associated with a card issuer entity (e.g., an issuing bank). Operations 302 and onward may be performed by one or more processors of a computing device such as, for example, the processor 200 (FIG. 2A) of suitably configured instances of the example computing device 105 (FIG. 2A).

The computing system detects a first resource transfer that is initiated using a first value transfer card. In at least some implementations, the first resource transfer may be a transaction that occurs at a terminal device. A cardholder may initiate a transaction by swiping, dipping, or tapping the first value transfer card at a payment (e.g., POS) terminal. For example, when the cardholder desires to make a purchase (e.g. in-store purchase) from a merchant, the first value transfer card may be inserted into a POS terminal, starting a card session. The cardholder may be prompted to enter a password for authentication purposes. Once the password is verified, the first value transfer card may be used to make a payment towards the purchase.

As another example, the terminal device may be an automated teller machine (ATM). The cardholder may insert the first value transfer card into an ATM and input a password, such as a personal identification number (PIN), that is associated with the value transfer card or an account (e.g. banking account) that is connected to the value transfer card. Once the cardholder has been authenticated to a card session, they can manually conduct one or more account-related operations (e.g., deposits, bill payments, withdrawals, etc.) using the ATM.

In some implementations, the first resource transfer may be a transaction that occurs online. For example, the cardholder may enter and/or confirm card details of the first value transfer card in order to make a purchase transaction at an online POS (e.g., a payment page on a merchant website or a mobile app). The first value transfer card may then be identified as the selected payment method for the online transaction.

The computing system detects the first resource transfer when a transaction request associated with the card transaction is received by the system, via a payment gateway or processor. That is, a transaction request including details of the transaction is forwarded by the payment terminal or online gateway to the computing system. Upon detecting the first resource transfer, the computing system captures transfer data of the first resource transfer. The transfer data may include, for example, card details (e.g., card number, expiration date, cardholder identifier, billing address, etc.), transaction data such as location, currency, and amount of the transaction, and merchant information.

Since different value transfer cards have different card features and benefits, it is desired to automatically and expeditiously (e.g., in real-time or near real-time) present a cardholder with information identifying alternative cards that can be used for a given resource transfer, to maximize accrued benefits for the cardholder. In particular, such information should be presented to the cardholder at the time of initiating the resource transfer using the first value transfer card. Upon detecting the first resource transfer, the computing system identifies at least one alternative value transfer card for processing the first resource transfer (operation 304). The alternative value transfer card represents an “optimal” card to use for the first resource transfer. More specifically, the alternative value transfer card may be a card that, if used for the first resource transfer, results in greater accrued benefits compared to the first value transfer card. For example, the alternative value transfer card may produce maximum accrued benefits among all available value transfer cards of the cardholder when it is used to execute the first resource transfer.

To provide the cardholder with the opportunity to select a different value transfer card for the first resource transfer, the computing system is configured to temporarily interrupt processing of the first resource transfer. More specifically, the processing flow of the first resource transfer is temporarily halted. In at least some implementations, the computing system may cause the first resource transfer to be placed “on hold”. For example, the computing system may delay authorization of the first resource transfer at least until the cardholder is afforded the opportunity to choose between their value transfer cards for processing the first resource transfer. In the instance of a card transaction, the transaction request may be forwarded to the computing system and authorization of the transaction (i.e., approving or declining the transaction) may be delayed at least until a defined series of operations for presenting alternative card options for the card transaction have been executed.

The alternative value transfer card is identified based on (1) transfer data of the first resource transfer (e.g., transaction data), and (2) card data associated with the first value transfer card and one or more other value transfer cards. In at least some implementations, the computing system obtains a first rewards profile associated with the first value transfer card and a second rewards profile associated with an alternative value transfer card. Each rewards profile indicates a quantity of rewards that would accrue to the cardholder when the respective card is used to process the first resource transfer. The computing system may, for example, query a loyalty management system to obtain the rewards profiles of one or more value transfer cards of the cardholder. The rewards profile of a card may indicate types and quantities of rewards that accrue for each of a plurality of different types of resource transfers. In particular, the rewards profile may include a mapping of resource transfer types to accruable rewards. The rewards quantity may be expressed as an absolute value or a percentage (e.g., percentage of transaction value).

In some implementations, a resource transfer type may relate to transaction category of a card transaction. For example, a resource transfer type for a card transaction may specify a category of a product/service that is purchased, such as groceries, gas, digital media, food delivery, travel, transit, drugstore products, rent, utilities, and the like. The computing system determines a first rewards quantity that accrues from processing the first resource transfer using the first value transfer card and a second rewards quantity that would accrue from processing the first resource transfer using the second value transfer card. The first and second rewards quantities are compared in determining whether the alternative value transfer card is preferred over the first value transfer card for the purposes of the first resource transfer. In particular, the computing system determines whether use of the alternative value transfer card would result in greater accrued benefits relative to the first value transfer card based on comparing the rewards quantities associated with the cards.

The computing system is also configured to assesses optimality of a cardholder's value transfer cards for a given transaction based on the card data of the value transfer cards. The card data may be stored in a database associated with an issuer server and/or resource account management system, and may be obtained by querying the database for value transfer cards belonging to the cardholder. In some implementations, the computing system may identify the alternative value transfer card on the basis of a currency of a card transaction. More particularly, the computing system may identify a currency of the card transaction and determine that the alternative value transfer card is preferred over the first value transfer card for transactions that are in the identified currency. For example, if the computing system determines, based on card data of the value transfer cards, that the alternative value transfer card is associated with a lower (or no) currency transaction fee, the alternative value transfer card may be deemed to be preferred or “optimal” relative to the first value transfer card.

In operation 306, the computing system presents, via a client computing device, a prompt for receiving selection of one of the first and alternative value transfer cards. In some implementations, the client computing device is a device at which the first resource transfer is initiated. For example, the client computing device may be POS terminal at which a card transaction using the first value transfer card is detected. Alternatively, the client computing device is a device associated with the cardholder. In some implementations, the computing system sends, to the client computing device, a message indicating a proposed change to the first resource transfer. The message may, for example, comprise a notification identifying the alternative value transfer card that is determined to be optimal, or preferred, relative to the first value transfer card. The message can be displayed as part of, or otherwise in conjunction with, the prompt presented on the client computing device.

The cardholder may provide input for selecting the first or alternative value transfer card. In response to determining that the selection is the first value transfer card, the computing system processes the first resource transfer using the first value transfer card (operation 308). For example, the computing system may approve the first resource transfer. In some implementations, the computing system may disable a “hold” that is placed on the first resource transfer, by proceeding to authorize the requested transfer of resources. The computing system may, for example, generate an authorization response for a transaction request associated with a card transaction that includes an approval message, and the response may be forwarded to a payment processor which notifies a merchant associated with the card transaction.

If no input is received within a defined time window (e.g., a transaction “hold” period) for selection, the computing system proceeds to process the first resource transfer using the first value transfer card. That is, a timeout condition with respect to the time window for selection may be interpreted to represent a desire to proceed with the original requested resource transfer, i.e., using the first value transfer card.

On the other hand, if the cardholder selects the alternative value transfer card, the computing system is configured to decline the first resource transfer (operation 310). The cardholder may, for example, provide input, via the prompt presented on the client computing device, for accepting a recommended change of value transfer card for processing the first resource transfer. The selection of the alternative value transfer card signals the cardholder's desire to use a different card for the first resource transfer. The computing system may disable a “hold” that is placed on the first resource transfer, by declining the transfer of resources. The computing system may, for example, generate an authorization response for a transaction request associated with a card transaction that includes a decline message.

The computing system may cause a transfer result for the first resource transfer (i.e., transfer approved or declined) to be displayed to the cardholder. The transfer result may be displayed, for example, via the client computing device (e.g., a POS terminal, merchant's website/app, etc.).

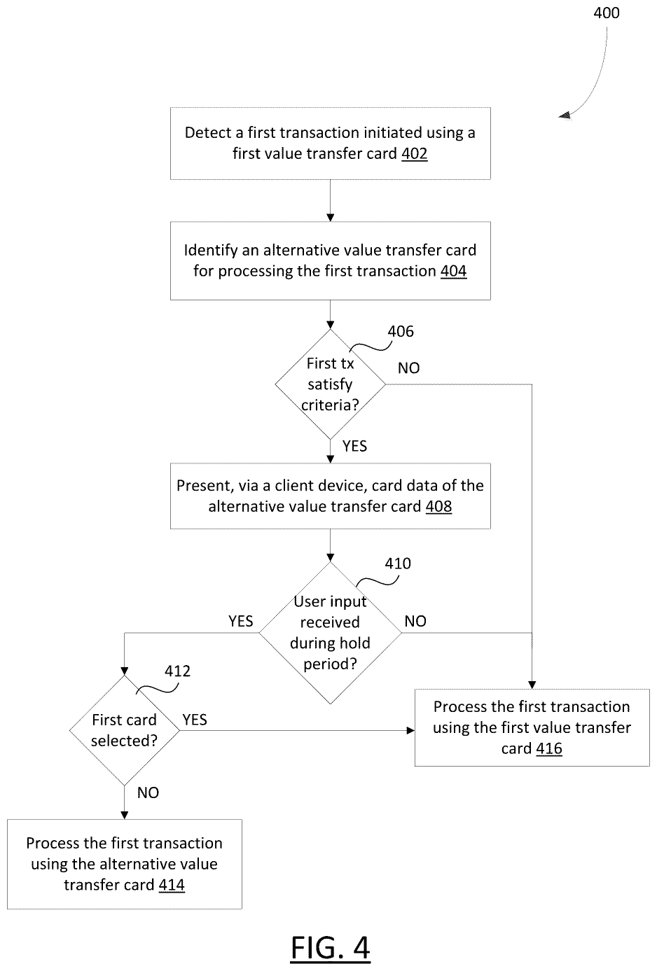

Reference is now made to FIG. 4 which shows, in flowchart form, an example method 400 for real-time processing of a resource transfer initiated using a value transfer card, with variable resource transfer hold periods. The method 400 may be implemented by a computing system associated with an issuer entity for the value transfer card. For example, the method 400 may be executed by a computing system implementing the card issuer server 140 or a resource server 130 that is associated with a card issuer entity (e.g., an issuing bank). Operations 402 and onward may be performed by one or more processors of a computing device such as, for example, the processor 200 (FIG. 2A) of suitably configured instances of the example computing device 105 (FIG. 2A). The operations of method 400 may be performed in addition to, or as alternatives of, one or more of the operations of method 300.

The computing system detects a first card transaction initiated using a first value transfer card, in operation 402. The first card transaction may be a payment transaction that occurs at a terminal device (e.g., a POS terminal, ATM, etc.) or at an online payment interface, such as a payment page of a merchant's website or app. The computing system may detect the first card transaction upon receiving, via a payment gateway or processor, a transaction request containing details of the first card transaction.

In operation 404, the computing system identifies at least one alternative value transfer card that can be used for the first card transaction. The alternative value transfer card is a different card that is associated with the cardholder and that is suitable for use in processing the first card transaction. In particular, the computing system identifies an alternative value transfer having different card features than the first value transfer card. For example, the alternative value transfer card may be associated with a different quantity of accruing rewards in connection with the first card transaction compared to the first value transfer card. The accruing rewards information may be obtained by the computing system by, for example, querying a loyalty management system associated with the value transfer cards of the cardholder. As another example, the alternative value transfer card may be a card having a different currency transaction fee than the first value transfer card for the currency of the requested card transaction.

In operation 406, the computing system determines whether the first card transaction satisfies certain defined criteria. The criteria may relate to the benefits that accrue from card use in connection with the first card transaction. In some implementations, the computing system may assess the relative rewards benefits associated with using different value transfer cards for the requested card transaction. More particularly, the computing system determines a first value of rewards associated with use of the first value transfer card for the card transaction and a second value of rewards associated with use of the alternative value transfer card. A difference between the first value and the second value is computed, and the first card transaction may be determined to satisfy rewards criteria if the computed difference exceeds a defined threshold value. The assessment of the relative values of accrued rewards allows for decisioning on whether to proceed with presenting the cardholder for options for optimal card use. In particular, a requested card transaction may be processed as-is, i.e., using the first value transfer card, if the transaction is determined to be within some defined tolerance for suboptimal card use. The cardholder may define this tolerance level, for example, by specifying the threshold value of the difference between the values of accruing rewards.

In some implementations, the computing system may assess the relative savings on currency transaction fees associated with using the different value transfer cards. The computed value of the relative savings may be compared against a defined threshold in order to determine whether the alternative value transfer card should be presented to the cardholder as an option for use in processing the requested card transaction.

If the first card transaction does not satisfy the defined criteria (e.g., computed difference is less than the threshold value), the computing system proceeds to process the requested card transaction using the first value transfer card. For example, the computing system may cause the first card transaction to be processed by authorizing the transaction without delay or “hold” on the transaction. An authorization response including an approval message may be generated by the computing system and routed to the relevant payment processor.

On the other hand, if the first card transaction does satisfy the defined criteria, the alternative value transfer card data may be presented to the cardholder (operation 408). That is, if the computed difference in relative values of accruing rewards exceeds a threshold representing a defined tolerance level for suboptimal card use, the computing system is configured to enable the cardholder to select a different value transfer card for the requested card transaction. The alternative value transfer card data may be provided as part of, or in conjunction with, a prompt for receiving user input of a selection of a value transfer card for the requested card transaction. The prompt may include the first value transfer card and the alternative value transfer card as selectable options, and card data, including respective values of accruing rewards for the requested card transaction, may be displayed with the prompt.

In at least some implementations, the computing system causes the first card transaction to be placed “on hold”. For example, the computing system may delay authorization of the first card transaction at least until the cardholder is afforded the opportunity to choose between their value transfer cards for processing the first card transaction. In particular, the transaction request for the first card transaction may be forwarded to the computing system and authorization of the transaction (i.e., approving or declining the transaction) may be delayed at least until a defined series of operations for presenting alternative card options for the card transaction have been executed. The prompt, presented on the client computing device, for receiving card selection may be displayed for the duration of the transaction hold period.

If user input for selecting a value transfer card is not received during the transaction hold period (operation 410), the computing system proceeds to process the requested card transaction using the first value transfer card. That is, a timeout condition with respect to a time window (i.e., transaction hold period) for selection may be interpreted to represent a desire to proceed with the original requested card transaction, i.e., using the first value transfer card.

In some implementations, the length of the transaction hold period may depend on a value of the requested card transaction and/or expected benefit (e.g., accruing rewards, transaction fee savings, etc.) in switching to a different value transfer card. The transaction hold period may generally be longer for higher value transactions (e.g., expensive purchases) while it may be shorter for lower value transactions. A longer transaction hold period affords the cardholder more time to review the relative rewards benefits associated with the different card use to process the requested card transaction.

If user input of a card selection is received and the alternative value transfer card is selected (operation 412), the computing system may process the requested card transaction using the alternative value transfer card, in operation 414. Alternatively, the computing system may simply cause the requested card transaction to be declined, without processing it using the alternative value transfer card. For example, the computing system may generate an authorization response to the associated transaction request that includes a decline message, and the authorization response may be routed to the relevant payment processor to effect a decline of the requested card transaction.

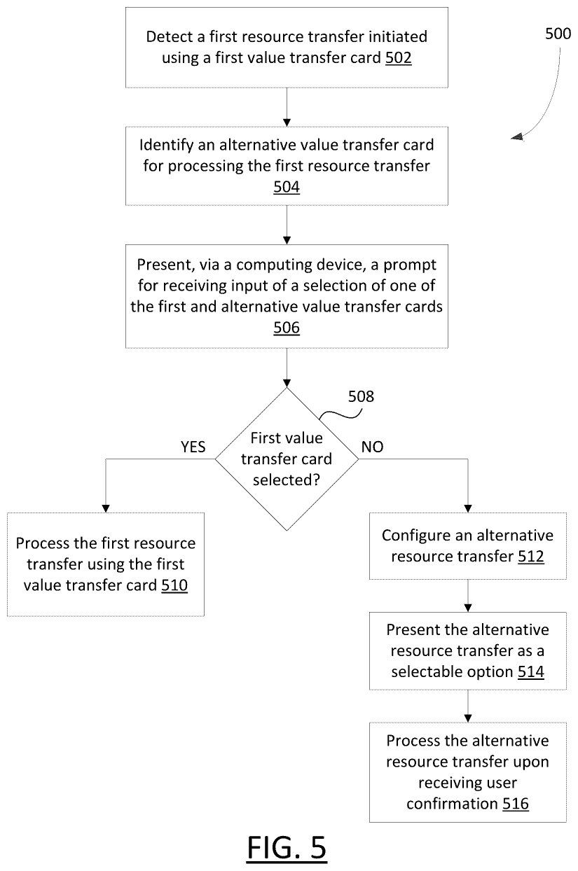

Reference is now made to FIG. 5 which shows, in flowchart form, another example method 500 for real-time processing of resource transfers initiated using a value transfer card. The method 500 may be implemented by a computing system associated with an issuer entity for the value transfer card. For example, the method 500 may be executed by a computing system implementing the card issuer server 140 or a resource server 130 that is associated with a card issuer entity (e.g., an issuing bank). Operations 502 and onward may be performed by one or more processors of a computing device such as, for example, the processor 200 (FIG. 2A) of suitably configured instances of the example computing device 105 (FIG. 2A). The operations of method 500 may be performed in addition to, or as alternatives of, one or more of the operations of methods 300 and 400.

In operation 502, the computing system detects a first resource transfer that is requested using a first value transfer card. The first resource transfer may, for example, be a card transaction that occurs at a terminal device (e.g., a POS terminal, ATM, etc.) or at an online payment interface, such as a payment page of a merchant's website or app. The computing system may detect the card transaction upon receiving, via a payment gateway or processor, a transaction request containing details of the first card transaction.

The computing system identifies an alternative value transfer card for processing the first resource transfer, in operation 504. The alternative value transfer card may be a card belonging to the cardholder that is suitable for use for the first resource transfer. In operation 506, the computing system presents, via a client computing device, a prompt for receiving input of a selection of one of the first and alternative value transfer cards. If the first value transfer card is selected by the cardholder (operation 508), the first resource transfer is processed using the first value transfer card (operation 510). Operations 502 to 510 may be performed in a similar manner as operations 302 to 310 of method 300 in FIG. 3.

If, on the other hand, the cardholder inputs selection of the alternative value transfer card, the computing system may be adapted to configure a second, different resource transfer using the alternative value transfer card (operation 512). In at least some implementations, the second resource transfer may comprise same transfer data as the first resource transfer with the exception of the value transfer card that is used to process the transfer. That is, the first and second resource transfers may differ only in the identity of the card used for initiating the requested transfer.

The second resource transfer is then presented as a selectable option, in operation 514. In some implementations, the transfer data of the second resource transfer is displayed on a client computing device associated with the first resource transfer. For example, the second resource transfer may be displayed on a terminal device (e.g., a POS terminal) or a transfer interface (e.g., payment page of a merchant's website/app) as an alternative to the requested resource transfer. The card data of the alternative value transfer card may be provided with the display data associated with the second resource transfer.

Upon receiving confirmation by the cardholder, the computing system processes the second resource transfer, in operation 516. That is, an alternative resource transfer that differs from the requested first resource transfer in at least the identity of value transfer card used to initiate the transfer is processed by the computing system.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing computer-executable instructions that, when executed by the processor, configure the processor to:
detect a first resource transfer initiated using a first value transfer card at an automatic teller machine (ATM) or a point-of-sale (POS);
identify an alternative value transfer card for processing the first resource transfer based on transfer data of the first resource transfer and card data of the first and alternative value transfer cards;
present, via a computing device, a prompt for receiving input of a selection of one of the first and alternative value transfer cards;
in response to determining that the selection is the first value transfer card, process the first resource transfer using the first value transfer card based on generating an authorization response comprising an approval message for the first resource transfer; and
in response to determining that the selection is the alternative value transfer card, generate an authorization response comprising a decline message for the first resource transfer.

2. The computing system of claim 1, wherein identifying the alternative value transfer card comprises:
obtaining a first rewards profile associated with the first value transfer card and a second rewards profile associated with the alternative value transfer card, the rewards profiles indicating quantities of rewards that accrue from processing resource transfers using the respective cards;
determining a first rewards quantity associated with the first value transfer card and a second rewards quantity associated with the second value transfer card based on the first and second rewards profiles, respectively; and
comparing the first and second rewards quantities.

3. The computing system of claim 1, wherein identifying the alternative value transfer card comprises:
determining a first currency associated with the first resource transfer; and
determining that the alternative value transfer card is preferred over the first value transfer card for resource transfers in the first currency.

4. The computing system of claim 1, wherein presenting the prompt comprises sending, to the computing device, a notification indicating a proposed change to the first resource transfer, the notification identifying the alternative value transfer card.

5. The computing system of claim 4, wherein the notification is presented via the computing device for a defined period of time that begins when the first resource transfer is detected.

6. The computing system of claim 5, wherein the instructions, when executed, further configure the processor to:
in response to determining that a selection is not inputted within the defined period of time, cease presenting the prompt via the computing device and process the first resource transfer using the first value transfer card.

7. The computing system of claim 1, wherein the instructions, when executed, further configure the processor to:
in response to determining that the selection is the alternative value transfer card, cause a second resource transfer to be initiated using the alternative value card transfer by configuring the second resource transfer using transfer data of the first resource transfer.

8. The computing system of claim 1, wherein the computing device comprises a point-of-sale terminal at which the first resource transfer is detected.

9. The computing system of claim 5, wherein a length of the defined period of time depends on a resource transfer value of the first resource transfer.

10. The computing system of claim 1, wherein the instructions, when executed, further configure the processor to:
determine a first value of rewards associated with use of the first value transfer card for the first resource transfer and a second value of rewards associated with use of the alternative value transfer card;
compute a difference between the first value and the second value; and
in response to determining that the computed difference does not exceed a defined threshold, process the first resource transfer using the first value transfer card.

11. A computer-implemented method, comprising:
detecting a first resource transfer initiated using a first value transfer card at an automatic teller machine (ATM) or a point-of-sale (POS);
identifying an alternative value transfer card for processing the first resource transfer based on transfer data of the first resource transfer and card data of the first and alternative value transfer cards;
presenting, via a computing device, a prompt for receiving input of a selection of one of the first and alternative value transfer cards;
in response to determining that the selection is the first value transfer card, process the first resource transfer using the first value transfer card based on generating an authorization response comprising an approval message for the first resource transfer; and
in response to determining that the selection is the alternative value transfer card, generate an authorization response comprising a decline message for the first resource transfer.

12. The method of claim 11, wherein identifying the alternative value transfer card comprises:
obtaining a first rewards profile associated with the first value transfer card and a second rewards profile associated with the alternative value transfer card, the rewards profiles indicating quantities of rewards that accrue from processing resource transfers using the respective cards;
determining a first rewards quantity associated with the first value transfer card and a second rewards quantity associated with the second value transfer card based on the first and second rewards profiles, respectively; and
comparing the first and second rewards quantities.

13. The method of claim 11, wherein identifying the alternative value transfer card comprises:
determining a first currency associated with the first resource transfer; and
determining that the alternative value transfer card is preferred over the first value transfer card for resource transfers in the first currency.

14. The method of claim 11, wherein presenting the prompt comprises sending, to the computing device, a notification indicating a proposed change to the first resource transfer, the notification identifying the alternative value transfer card.

15. The method of claim 14, wherein the notification is presented via the computing device for a defined period of time that begins when the first resource transfer is detected.

16. The method of claim 15, further comprising in response to determining that a selection is not inputted within the defined period of time, ceasing presenting the prompt via the computing device and process the first resource transfer using the first value transfer card.

17. The method of claim 11, further comprising in response to determining that the selection is the alternative value transfer card, causing a second resource transfer to be initiated using the alternative value card transfer by configuring the second resource transfer using transfer data of the first resource transfer.

18. The method of claim 11, wherein the computing device comprises a point-of-sale terminal at which the first resource transfer is detected.

19. The method of claim 15, wherein a length of the defined period of time depends on a resource transfer value of the first resource transfer.

20. The method of claim 11, further comprising:
determining a first value of rewards associated with use of the first value transfer card for the first resource transfer and a second value of rewards associated with use of the alternative value transfer card;
computing a difference between the first value and the second value; and
in response to determining that the computed difference does not exceed a defined threshold, processing the first resource transfer using the first value transfer card.
